(19) United States
(12) Patent Application Publication
(10) Pub. No.: US 2025/0181029 A1
(43) Pub. Date: Jun. 5, 2025

(54) SYSTEM AND METHOD OF PROVIDING INTERNET-BASED TEACHING UTILIZING A HOLOGRAPHIC PROJECTION

(71) Applicant: CARROLL BECK, INC., Dallas, TX (US)

(72) Inventors: Marilyn Carroll, Dallas, TX (US); Kyle Morton, Dallas, TX (US)

(21) Appl. No.: 18/417,099

(22) Filed: Jan. 19, 2024

Related U.S. Application Data
(60) Provisional application No. 63/606,523, filed on Dec. 5, 2023.

(51) Int. Cl. G03H 1/04

(52) U.S. Cl. CPC G03H 1/0402; G03H 2001/0428; G03H 2001/0452; G03H 2210/42; G03H 2210/62

(57) ABSTRACT

A system and method of providing internet-based teaching utilizing a holographic projection is disclosed. The system receives a query from a user via a user device. The system parses the query and generates a response to the query. The system generates a holographic image emulating a real-life educator. Further, the system generates a voice response corresponding to the response. The system integrates the holographic image and the voice response and presents it at the user device in order to create an impression that a real-life professor responded to the query. The system captures the essence of in-person instruction, offering students a uniquely engaging and adaptive educational journey in the digital realm.

### REFERENCE TO RELATED APPLICATIONS

The present application claims priority from U.S. Provisional Patent Application Ser. No. 63/606,523; filed Dec. 5, 2023; all of which is incorporated herein by reference.

### FIELD OF THE INVENTION

The present invention relates to internet-based teaching. More specifically, the present invention relates to a system and method of providing internet-based teaching utilizing a holographic projection.

### BACKGROUND OF THE INVENTION

It is known that education technology, commonly referred to as EdTech, has seen various innovations aimed at improving the learning experience, especially in an online context. The EdTech involved integration of various technological tools to improve the educational outcomes such as making learning more engaging and interactive while also delivering to large audiences. In addition, research has gained traction the application of a fuzzy logic to education. Fuzzy logic, which deals with approximate rather than fixed and exact reasoning, was seen as a potential tool to deal with the complexities and ambiguities inherent in the learning process. Fuzzy logic enabled systems to make decisions based on imprecise or vague inputs, mirroring human decision-making processes. Coupled with artificial neural networks (ANNs), which are computing systems inspired by the neural networks that constitute animal brains, there was a promising foundation to build systems that could emulate human-like teaching and adaptability.

Several solutions incorporating the fuzzy logic and/or ANN in EdTech have been disclosed in the past. One such example is disclosed in a Chinese Publication No. 110531849, entitled “Augmented reality intelligent teaching system based on 5G communication” (“the '849 Publication”). The '849 Publication discloses an augmented reality intelligent teaching system based on 5G communication in which data sound information and face image information of students are obtained through an information obtaining device. A preset artificial intelligence algorithm model automatically determines the learning state of the students according to sound and the facial expressions of the students. An AR display device is controlled to display a three-dimensional figure model and a three-dimensional learning scene to push related learning contents to the students. Through the above technical scheme, the students can directly communicate with the three-dimensional animation model with high interest. The artificial intelligence algorithm model can enable the students to achieve a convenient and efficient learning effect, and the self-adaptive learning algorithm enables the artificial intelligence algorithm model to be continuously self-optimized along with training.

Another example is disclosed in an Indian Publication No. 202311009965, entitled “LEARNING SYSTEM AND METHOD WITH AI TUTOR” (“the '965 Publication”). The '965 Publication discloses a learning system with an artificial intelligence (AI) tutor. The AI tutor includes an analysis module for analysing and classifying communication received from a learner device. The AI tutor includes a course module for determining a course to be delivered to the learner device based on the analysed and classified communication. The AI tutor includes a delivery module for delivering the determined course to the learner device in one or more learning sessions. The AI tutor may include an engagement module for managing the one or more learning sessions.

Although the above discussed disclosures are useful, they have few problems. For example, traditional online learning solutions often provide standardized content without considering individual students' diverse learning needs, preferences, and backgrounds. Further, online platforms need to capture the attention and interest of students effectively, leading to decreased retention rates and reduced learning outcomes. Furthermore, the absence of a tangible, human-like presence in online learning platforms often made learners feel isolated or disconnected from the learning process. The absence of physical presence can make it harder for students to feel connected and engaged with instructors and peers, potentially leading to isolation. Further, without the structured environment of a physical classroom, students may struggle with distractions at home and have difficulty managing their time effectively. Furthermore, online interactions may lack the depth and quality of face-to-face conversations, making it challenging to build strong relationships and engage in nuanced discussions.

Therefore, there is a need in the art to provide an adaptive learning system that integrates a user-friendly and engaging interface, such as a holographic representation of a professor/educator and while incorporating fuzzy logic and ANNs to create a more immersive, adaptive, and personalized learning experience.

### SUMMARY OF THE INVENTION

It is an object of the present invention to provide an adaptive learning system that integrates a user-friendly and engaging interface and that avoids the drawbacks of known online learning systems.

It is another object of the present invention to provide a system that emulates a professor/educator and designed to enrich education in both online and on-ground classes by providing personalized and engaging feedback using advanced technologies.

It is another object of the present invention to provide a system that presents and automated feedback and responses, in both written and in a holographic video format while also delivering sound like a specific professor/educator.

In order to overcome one or more objects, the present invention presents a system for providing internet-based teaching utilizing multi-media and holographic type projection. The system receives a query from a user via a user device. The system parses the query and generates a response to the query. The system generates a holographic image emulating a real-life professor/educator. Further, the system generates a voice response corresponding to the response. The system integrates the holographic image and the voice response and presents it to the user device in order to create an impression that a real-life professor responded to the query.

In one aspect of the present invention, the system integrates with online learning management systems (LMSs) to facilitate the delivery of educational courses, training programs, learning and development initiatives.

In another aspect of the present invention, the system uses Fuzzy Logic (FL) and Artificial Neural Networks (ANNs) to determine students' learning styles and offer individualized feedback and recommendations. The system uses the FL to assess and interpret the nuances in the user queries, ensuring contextually relevant feedback. Further, the system uses the ANN to learn from interactions, continuously making its responses more precise.

In one advantageous feature of the present invention, the system offers an intersection of educational technology and artificial intelligence, by focusing on integrating Fuzzy Logic (FL), Artificial Neural Networks (ANNs), and Cinematography to produce a holographic representation of educators for personalized online learning experiences. The above combination aims to replicate the benefits of in-person instruction in an online environment, catering to a broader range of learning styles and preferences. Further, the system engages the users through a visually appealing and interactive interface. Further, the system offers specialized versions of the holographic professors for distinct subjects, each equipped with content and teaching methods tailored to their respective disciplines.

In another advantageous feature of the present invention, the system utilises the Fuzzy Logic (FL) and Artificial Neural Networks (ANNs) that interpret vague or ambiguous inputs from the user and adjusts its teaching methods accordingly.

In another advantageous feature of the present invention, the system obtains feedback from the user and utilises the feedback to refine subsequent interactions and content delivery.

In another advantageous feature of the present invention, the system provides a combination of effective online teaching strategies, supportive technology, and resources to ensure that students remain engaged and motivated throughout their online educational experience.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF DRAWINGS

A more complete understanding of the invention and its many advantages thereof will be readily appreciated as the same becomes better understood by reference to the following detailed description, when considered in connection with the accompanying drawings wherein:

FIG. 1 illustrates an environment in which a system for providing internet-based teaching utilizing a holographic projection implements, in accordance with one embodiment of the present invention;

FIG. 2 illustrates a block diagram of the system, in accordance with one embodiment of the present invention;

FIG. 3 illustrates a block diagram of an electronic device, in accordance with one embodiment of the present invention;

FIG. 4 illustrates a method of setting up the system, in accordance with one embodiment of the present invention;

FIG. 5 illustrates an architectural diagram of the system, in accordance with one embodiment of the present invention; and

FIG. 6 illustrates a method of providing internet-based teaching utilizing a holographic projection, in accordance with one embodiment of the present invention.

### DETAILED DESCRIPTION OF THE INVENTION

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed system. However, it will be apparent to those skilled in the art that the presently disclosed invention may be practiced without these specific details. In some instances, well-known structures and devices are shown in functional or conceptual diagram form in order to avoid obscuring the concepts of the presently disclosed system.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a system, it is to be further understood that numerous changes may arise in the details of the embodiments of the system. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

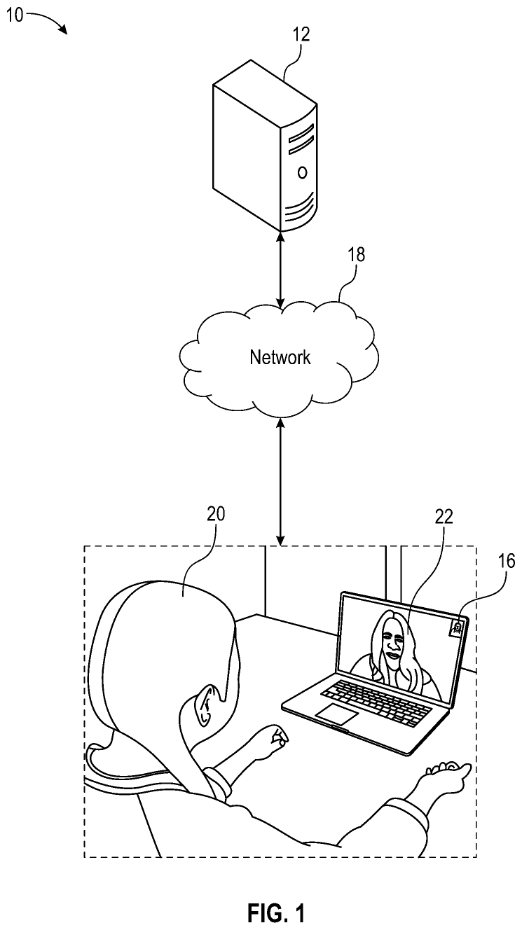

Various features and embodiments of a system for providing internet-based teaching utilizing a holographic projection are explained in conjunction with the description of FIGURES (FIGS. 1-6.

FIG. 1 shows an environment 10 in which a system 12 implements, in accordance with one embodiment of the present invention. System 12 indicates a server being operated or managed by an educational institute or education technology (EdTech) service provider. System 12 communicatively connects to a plurality of user devices 16 via a network 18. An example of user device 16 includes, but not limited to, a mobile device, a personal digital assistant, a laptop computer, a tablet computer, a desktop computer etc. Network 18 includes a wireless network, a wired network or a combination thereof. Network 18 can be implemented as one of the different types of networks, such as intranet, local area network (LAN), wide area network (WAN), the internet, and the like. Network 18 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 18 includes a variety of network devices, including routers, bridges, servers, computing devices, storage devices, and the like. In the present invention, a user 20 such as a student operates user device 16 to access system 12. Here, system 12 presents a holographic image 22 on user device 16 and delivers/provides online teaching to user 16.

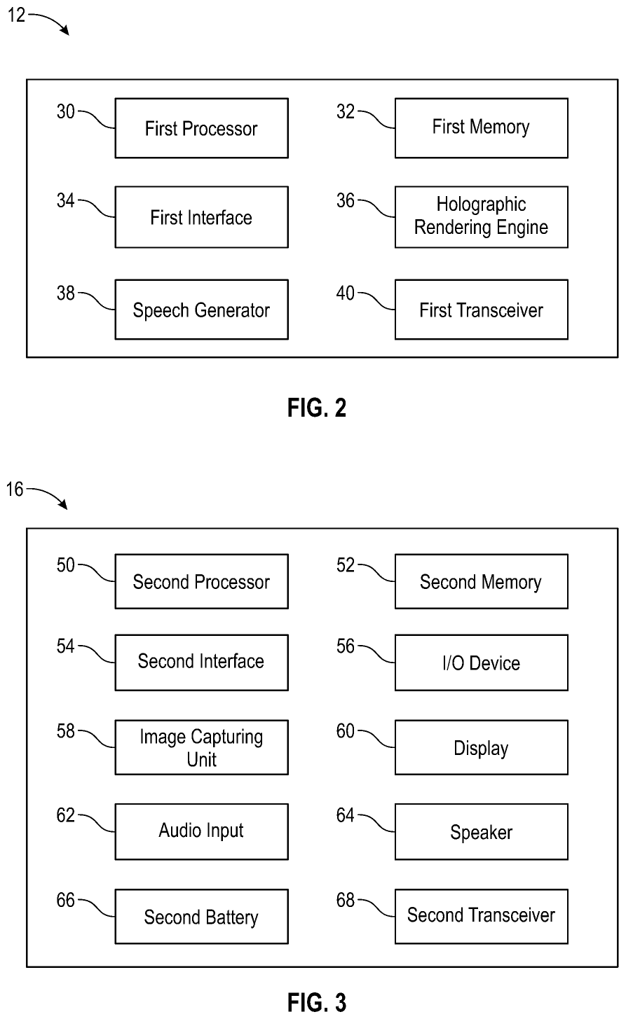

FIG. 2 shows a block diagram of system 12, in accordance with one embodiment of the present invention. System 12 encompasses a first processor 30. First processor 30 includes one or more commonly known CPUs such as a microprocessor or a microcontroller. It should be understood that first processor 30 is responsible for implementing specific functions under the control of software including an operating system, and any appropriate applications software. System 12 includes a first memory 32 connected to first processor 30 via a data bus (not shown). First memory 32 includes a volatile memory and/or a non-volatile memory. Preferably, first memory 32 stores program instructions or software programs that interact with the other devices such as user device 16 as described below. In one implementation, first processor 30 executes the program instructions stored in first memory 32 in any suitable manner. In one implementation, first memory 32 stores digital data indicative of documents, files, programs, web pages, etc. retrieved from user device 16.

System 12 includes a first interface 34. First interface 34 includes a wired interface and/or a wireless interface. In one implementation, first interface 34 includes functionality similar to at least a portion of functionality implemented by one or more computer system interfaces such as those described herein and/or generally known to one having ordinary skill in the art. In some examples, system 12 includes a display (not shown).

System 12 includes a holographic rendering engine 36. Holographic rendering engine 36 captures images of a plurality of real-life educators/professors and generates virtual realistic avatars of and for the professors. In one example, holographic rendering engine 36 generates virtual holographic 2-dimensional or 3-dimensional image that emulates the professor using cinematography techniques. In order to generate the virtual holographic 2-dimensional or 3-dimensional image, at first, system 12 obtains high resolution images of the real-life professors. Here, system 12 obtains one or more images to create different versions indicating different looks or appearances of the same educator/professor. System 12 processes digital representations from the images in three dimensions. Further, holographic rendering engine 36 applies texture mapping to the surfaces of three dimensional models. Optionally, holographic rendering engine 36 utilises cinematographic techniques to create a more immersive, adaptive, and personalized learning experience for users 20. This enhances the visual realism of the image in the holographic environment. Further, system 12 controls the appearance of surfaces, lighting and visual effects on the holographic environment. Subsequently, holographic rendering engine 36 performs spatial mapping of the physical space where the holographic image needs to be projected. Further, the three-dimensional model is transformed into a two dimensional holographic image to be displayed on the display. In one example, holographic rendering engine 36 presents a holographic classroom setting where multiple holographic projections of students and educators interact, facilitating real-time virtual interactions.

Further, system 12 includes a speech generator 38. Speech generator 38 is configured to convert text to spoken words. In other words, speech generator 38 is used to perform voice synthesis in order to deliver output in the voice of the real-life educator/professor. In the present invention, speech generator 38 is used to produce human-like speech by simulating the natural rhythm, intonation and pronunciation of a human voice. As specified above, system 12 utilises images of real-life professors/educators and generates realistic avatars for the professors. Corresponding to each professor, system 12 captures voice samples of the real-life professors. In one example, system 12 captures pre-recorded speech segments from the real-life professors. Subsequently, system 12 concatenates the pre-recorded speech segments to form complete words and sentences. In one implementation, system 12 utilises one or more statistical models or voice synthesis models to generate the speech. Examples of the voice synthesis models include, but not limited to, Hidden Markov Model, Neural Network, etc.

Further, system 12 includes a first wireless communication module(s)/transceiver 40. First transceiver 40 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

FIG. 3 shows a block diagram of user device 16, in accordance with one embodiment of the present invention. User device 16 includes a second processor 50. Second processor 50 includes one or more commonly known CPUs such as a microprocessor or a microcontroller. It should be understood that second processor 50 is responsible for implementing specific functions under the control of software including an operating system, and any appropriate applications software. User device 16 includes a second memory 52 such as a volatile memory (e.g., RAM), non-volatile memory (e.g., disk memory, FLASH memory, EPROMs, etc.), unalterable memory, and/or other types of memory. In one implementation, second memory 52 is configured or designed to store data, program instructions. The program instructions control the operation of an operating system and/or one or more applications. User device 16 includes a second interface 54. Second interface 54 includes a wired interface and/or a wireless interface. In one implementation, second interface 54 includes functionality similar to at least a portion of functionality implemented by one or more computer system interfaces such as those described herein and/or generally known to one having ordinary skill in the art. User device 16 includes an Input/Output (I/O) device 56 such as a keyboard, buttons, etc.

Further, user device 16 includes an image capturing unit 58 such as a camera for capturing image or video of user 20. User device 16 includes a display 60 for displaying text, image or video. In the present invention, display 60 displays the holographic image 22 of the professor on user device 16. User device 16 includes an audio input 62 such as a microphone for capturing the voice of user 20. User device 16 includes a speaker 64 for producing sounds.

User device 16 includes a second battery 66. Second battery 66 indicates a rechargeable battery such as a Lithium Ion (Li-ion) battery. Second battery 66 is charged using a cable (not shown) via a charging port (not shown). Optionally, second battery 66 is charged wirelessly using inductive charging or charging pad (not shown) as known in the art. Further, user device 16 includes a second wireless communication module(s)/transceiver 68. Second transceiver 68 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

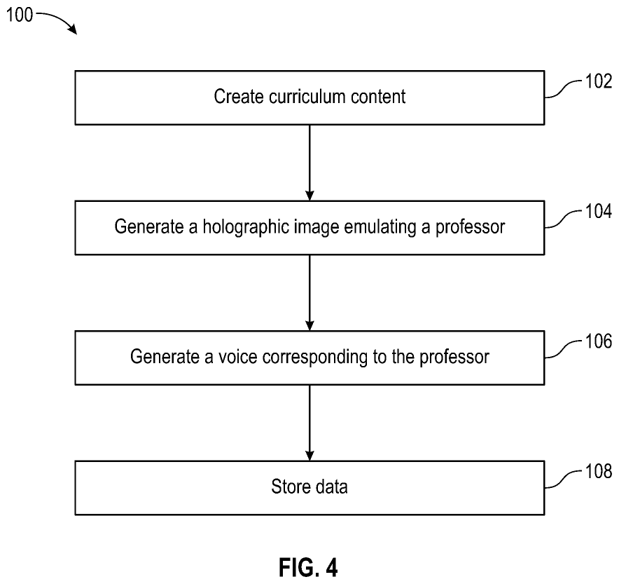

Now referring to FIG. 4, a method 100 of setting up system 12 is explained, in accordance with one exemplary embodiment of the present invention. The order in which method 100 is described should not be construed as a limitation, and any number of the described method blocks can be combined in any order to implement method 100 or alternate methods. Additionally, individual blocks may be deleted from method 100 without departing from the spirit and scope of the invention described herein. Furthermore, method 100 can be implemented in any suitable hardware, software, firmware, or combination thereof. However, for ease of explanation, in the embodiments described below, method 100 may be implemented using the above-described system 12.

At step 102, system 12 creates curriculum content. Here, the curriculum content indicates an education material and resources to be delivered through online, which can be accessed by users 22. The curriculum content is designed to support teaching and learning objectives in an online educational program. In one example, the curriculum content includes, but not limited to, text, multimedia, assessments, interactive learning modules, discussion forums, virtual labs, case studies, webinars, online workshops, etc. The interactive learning modules include activity based learning, quizzes, simulations, etc. In one example, system 12 is integrated with an online learning management system (LMS) to facilitate the delivery of educational courses, training programs, learning and development initiatives. The LMS may also include video conferencing, content authoring tools and other learning resources. In one example, system 12 integrates with the online learning management system (LMS) platforms such as Thinkific™, Blackboard™, Moodle™, Desire to Learn™, etc. In the present invention, the curriculum content is designed based on the target audiences and their learning requirements. In one example, the curriculum content is designed based on age, prior knowledge, invention (Mathematics, History, Science, etc.), learning skills, cultural background, assessment, etc.

In one example, system 12 integrates with LMS, referred to as EmpowerEd™ or EmpowerEd Pro™. The LMS is crafted to align with state and federal educational standards. The LMS offers a standalone application that users can interface with and receive real-time professor responses and engagement. The LMS is integrated with artificial intelligence for course creation, content management, and student tracking. In one example, system 12 is configured to present customizable interfaces for different course requirements. Further, the LMS is integrated with automated grading for quizzes, objective assignments, plagiarism detection and academic integrity tools. Optionally, the LMS presents explainer videos, interactive lessons, and multimedia content. Further, the LMS presents templates and guides for various types of instructional materials. The LMS is configured to securely store the data in order to protect sensitive educational data and to comply with global data protection regulations. In one example, system 12 is configured to generate reports with respect to student performance aligning with set standards. The reports can be reviewed to adjust course content and/or amend teaching practices.

At step 104, system 12 generates a holographic image 22 emulating a professor. As specified above, holographic rendering engine 36 captures images of the plurality of real-life professors and generates virtual realistic avatars of the professors for students/users. Here, system 12 generates holographic images for the real-life professors. In one example, system 12 assigns the holographic images based on the qualification and invention expertise of the professors. This way, system 12 displays the holographic image of the professor corresponding to his/her invention expertise or the curriculum content assigned to him/her. Concurrently or consecutively, system 12 generates a voice for each of the real-life professors, as shown at step 106. Here, system 12 pre-records speech segments from the real-life professors and generates voice samples with the help of speech generator 38. Optionally, system 12 utilises a diverse dataset or recorded human voices to train a model and uses the model to generate a voice for each of the holographic image or professor. At step 108, system 12 stores the holographic images and the corresponding voice data for the professors in first memory 32.

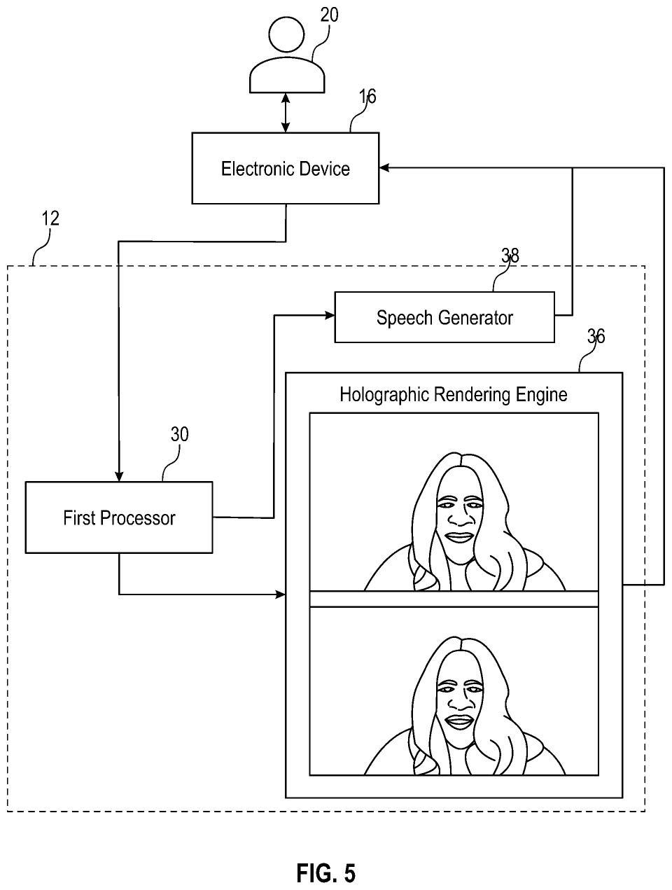

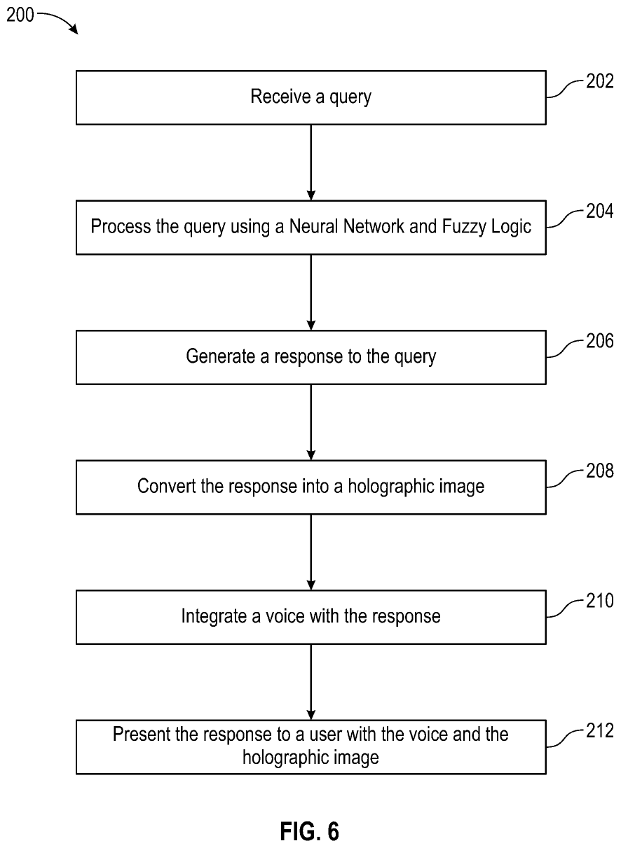

FIG. 5 shows an architectural diagram of system 12 for providing internet-based teaching utilizing a holographic projection. Referring to FIG. 6, a method 200 of providing internet-based teaching utilizing a holographic projection is explained with the help of FIG. 5, in accordance with one exemplary embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the invention described herein. Furthermore, method 200 can be implemented in any suitable hardware, software, firmware, or combination thereof. However, for ease of explanation, in the embodiments described below, method 200 may be implemented using the above-described system 12.

At first, system 12 requests user 20 to register and create a profile. Here, user 20 provides his/her name, age, interested topics/subject, assessments, learning modules, etc. In one example, system 12 creates the profile based on information including, but not limited to, demographic information, learning style assessment, performance tracking, personalised recommendations, adaptive learning pathways, mental health and wellbeing monitoring, predictive analytics, etc. The demographic information includes, but not limited to, age, location, educational background, interests, career goals, and learning preferences. The learning style assessment indicates preferred learning style such as visual, auditory, kinaesthetic, etc. The performance tracking indicates tracking of student performance across different courses and assignments for analysing strengths, weaknesses, and areas for improvement. The personalised recommendations indicate courses and resources suggested to user 20 based on student profiles and performance data that align with user's interests and goals. The adaptive learning pathways indicate custom learning pathways that adapt to the user's pace and style. This includes dynamic adjustment of course content and difficulty based on ongoing performance and feedback. The mental health and wellbeing monitoring indicate tools to assess and support user's mental health and stress levels. Additionally, the mental health and wellbeing monitoring includes resources for counselling and well-being practices. The predictive analytics include identifying potential challenges and opportunities for each user and predicting future performance trends. It should be understood that system 12 presents a series of questionaries' to capture information about user 20. Optionally, system 12 learns over a period of time and configures the profile based on the learning style and interests of user 20.

After providing the details, system 12 provides a unique identification number for user 20 to access system 12. In one example, system 12 creates the profile for user 20 containing information such as individualized learning plans, design components, structured tables for course content, student profiles with learning styles, history, and preferences, a library of learning plans, etc. In one example, system 12 presents a personalized student dashboard with course progress, reminders, and recommendations. In another example, system 12 prompts user 20 to access to online courses, webinars, and workshops. When user 20 accesses system 12, system 12 presents the curriculum content/webinars/workshops being delivered by holographic image 22 to user 20 on user device 16, as shown in FIG. 1, for example. In the present invention, system 12 delivers the curriculum content such that holographic image 22 emulates the real-life professor along with his/her voice. Here, system 12 employs holographic rendering engine 36 to render holographic image 22 by syncing the facial expression including movement of eyebrows, lips and other body parts as the voice commands are being provided by speech generator 38 corresponding to the curriculum content.

At any given point of time, user 20 inputs a query to system 12, as shown in step 202. In one example, user 20 inputs the query in the form of a text in a textbox/chat box provided in the application. Optionally, user 20 asks the query orally. Here, user device 16 captures the input and transmits the query to system 12, as shown in FIG. 5. First processor 30 receives the query and parses the query by breaking down the query into components or tokens. In one example, system 12 uses an Artificial Neural Networks (ANN) and a Fuzzy Logic (FL) to process the query, as shown in step 204. In one example, system 12 uses a combination of machine learning, natural language processing and other methods to understand the structure and semantics of the query. In another example, system 12 is trained on vast educational data sets using ANN in order to ensure a robust foundation for content delivery and adaptability. Based on the query, system 12 identifies and generates a response in first memory 32, as shown in step 206. Here, system 12 identifies the response in a textual format.

Subsequently, first processor 30 employs holographic rendering engine 36 to convert the response into a holographic image format, as shown at step 208. Here, holographic rendering engine 36 retrieves virtual holographic image 22 of the professor delivering the curriculum content. Holographic rendering engine 36 renders holographic image 22 such that holographic image 22 emulates the real-life professor facial expression/movement while the response is being delivered to user 20 on user device 16. Concurrently, first processor 30 employs speech generator 38 to generate the voice corresponding to the response to the query. As specified above, speech generator 38 produces human-like speech by simulating the natural rhythm, intonation and pronunciation of a human voice of the real-life professor.

After converting the response into holographic image 22 and producing human-like speech, first processor 30 integrates them together, as shown at step 210. Subsequently, first processor 30 transmits holographic image 22 and the speech to user device 16, as shown in step 212. When holographic image 22 and the speech are presented at user device 16, it creates an impression that a real-life professor is responding to the query posted by user 16. This creates a tangible and human-like presence in an online learning platform.

In some implementations, system 12 analyses facial expressions or follow up queries posed by user 20. If there is a follow up query, system 12 repeats the process as explained above. All the queries and responses provided are stored in first memory 32 to improve the accuracy of responses.

In one implementation, the system begins by taking inputs from text corresponding to educational content. The text is aligned with specific learning objectives that a student is expected to achieve. Here, the system assesses the student based on the desired outcomes. In order to assess the student, a learning model may be utilised. The system is configured to execute the learning model to capture the student's cultural background and environment, learning style of the student, any particular learning disabilities, etc. Based on the information captured, the system configures the approach based on the disabilities to foster engagement of the student in interacting with the system. In some instances, the system is configured to consider external factors such as compliance metrics and broader educational expectations. Here, the system is configured to adapt as the student interacts with the interface, primarily through learning modules. For instance, if a student named “John” answers a question, then the system doesn't merely indicate a right or wrong. Instead, the system employs positive reinforcement techniques. If John answers incorrectly, the system states the error thereby guiding John through understanding the mistake, ensuring a deeper grasp of the concept. This way, the system promotes adaptive learning, considering individual student differences while ensuring alignment with overarching educational goals.

As presented above, the system offers a real-time interaction between users/students and virtual avatars i.e., holographic images. Consider an example of the system being utilised in a discussion forum. Here, when a discussion topic poses the question, “Based on the value systems we studied, what career objective do you have?” a student might respond, “I aim for a career that lets me integrate community service and helping others into the position I'm seeking.” Upon receiving the response, the system evaluates the student's answer and may generate a reply/response, both in digital text and visual format. The visual format/representation includes the one or more holographic images of a real-life professor. If the professor's name is Molly and a student has met her in person, then system's response visually resembles Molly, making the digital interaction more personable and engaging. This way, the students feel they are interacting with a familiar person, enhancing the learning experience. In other words, the system blends technology with a touch of personalization, aiming to recreate the intimacy of a traditional classroom in a digital environment.

In some instances, the system can be used to teach students with learning disabilities like dyslexia and attention deficit hyperactivity disorder (ADHD). The system provides an alternative to traditional methods and even medication. The system bridges educational gaps by addressing individual challenges, ensuring all students can access adequate, tailored educational resources regardless of their unique needs.

In one example, the system tracks student's response/behaviour via the user device when the responses are provided by the holographic images of the real-life professor with the voice. If the students are not paying attention or appear to be disinterested, then the system modifies the holographic images. In one example, the system modifies the holographic images by changing movement of one of eyebrows, lips and body parts of the virtual realistic avatars in response to the feedback captured. This acts as a visual feedback, and change in visual representation enhances engagement, making the interaction feel more personal. Additionally, the system continually monitors the student's progress, adjusting its teaching strategies based on observed outcomes. Adjusting the teaching strategies include revisiting specific topics, introducing new formats, recommending external resources, etc.

The presently disclosed system provides several advantages over the prior art. The system presents an innovative educational tool utilising the principles of Fuzzy Logic, Artificial Neural Networks (ANNs), and Cinematography to create a dynamic, immersive, and personalized online learning experience. By projecting a lifelike holographic educator/professor, the presently disclosed system presents course content and adapts to individual student needs, preferences, and feedback in real-time. The system can interpret vague or ambiguous inputs/queries from the students/users, adjust its teaching methods accordingly, and engage the users through a visually appealing and interactive interface. The system simulates the richness of in-person instruction within the digital realm, providing the users with a tailored and engaging educational journey. The system can be configured to facilitate multiple users at the same time, where multiple holographic students and educators can interact in a virtual classroom, facilitating group discussions, team projects, and peer reviews.

The presently disclosed system presents an all-in-one platform designed to transform online education. The system integrates cutting-edge technology with intuitive design, offering a seamless experience for both instructors and students. The system addresses the core challenges of online education i.e., engagement, accessibility, and quality. The system offers creating interactive content, managing dynamic discussions, grading assignments efficiently, and offering unparalleled student support thereby ensuring a rich and compelling learning environment.

The system offers numerous benefits to students in an online learning environment as the students can access course materials anytime and anywhere, accommodating different learning schedules and styles. the system provides interactive learning materials such as videos, animations, and simulations that can make learning more engaging and cater to different learning preferences. The automated quizzes and assessments can provide instant feedback, helping students understand their progress and areas needing improvement. The adaptive learning technologies can tailor content to individual students' needs, allowing customized pacing and focus areas. The system integrated with digital libraries, online databases, and a vast array of internet resources provide students with a wealth of information for research and learning.

Applicants or inventors of the present invention intend to market the system as “Holographic Professor Bot” or any other suitable names.

The present invention has been described in particular detail with respect to various possible embodiments, and those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

It should be understood that components shown in FIGUREs are provided for illustrative purposes only and should not be construed in a limited sense. A person skilled in the art will appreciate alternate components that may be used to implement the embodiments of the present invention and such implementations will be within the scope of the present invention.

1. A method of providing internet-based teaching utilizing a holographic projection, said method comprising the steps of:
receiving, by a processor, a query from a user device, the query corresponding to a curriculum content comprising one of text, multimedia, assessments, interactive learning modules, discussion forums, virtual labs, case studies, webinars, and online workshops;
processing, by said processor, the query for generating a response from the curriculum content;
generating, by said processor, one or more holographic images of a real-life professor;
generating, by said processor, a voice corresponding to the real-life professor;
integrating, by said processor, the response with the voice and the one or more holographic images; and
transmitting, by said processor, the response to said user device such that the one or more holographic images emulate a facial expression of the real-life professor while producing a human-like speech with the voice on said user device.

2. The method of claim 1, further comprising producing, by said processor, the human-like speech by simulating the natural rhythm, intonation and pronunciation of a human voice of the real-life professor.

3. The method of claim 1, the step of processing the query comprising processing the query using an Artificial Neural Networks (ANN) and a Fuzzy Logic (FL).

4. The method of claim 1, the step of generating one or more holographic images comprising:
capturing, by said processor, images of a plurality of real-life professors; and
generating, by said processor, virtual realistic avatars of each real-life professor of the plurality of real-life professors.

5. The method of claim 4, further comprising generating, by said processor, the voice for each real-life professor of the plurality of real-life professors.

6. The method of claim 5, further comprising capturing, by said processor, voice samples of each real-life professor from pre-recorded speech segments for generating the voice corresponding to the response.

7. The method of claim 1, further comprising capturing, by said processor, a feedback of the user of said user device upon transmitting the response with voice and the one or more holographic images.

8. The method of claim 7, further comprising modifying, by said processor, the one or more holographic images by changing movement of one of eyebrows, lips and body parts of the virtual realistic avatars in response to the feedback captured.

9. A system for providing internet-based teaching utilizing a holographic projection, said system comprising:
a processor; and
a memory coupled to said processor, wherein said memory stores program instructions executed by said processor, to:
receive a query from a user device;
process the query for generating a response;
generate one or more holographic images of a real-life professor;
generate a voice corresponding to the real-life professor;
integrating the response with the voice and the one or more holographic images; and
transmit the response to said user device such that the one or more holographic images emulate a facial expression of the real-life professor while producing a human-like speech with the voice on said user device.

10. The system of claim 9, wherein the processor executes the program instructions to produce the human-like speech by simulating the natural rhythm, intonation and pronunciation of a human voice of the real-life professor.

11. The system of claim 9, wherein the processor executes the program instructions to process the query using an Artificial Neural Networks (ANN) and a Fuzzy Logic (FL).

12. The system of claim 9, wherein the processor executes the program instructions to capture images of plurality of real-life professors, and generate virtual realistic avatars of the plurality of real-life professors.

13. The system of claim 12, wherein the processor executes the program instructions to generate the voice for each real-life professor of the plurality of real-life professors.

14. The system of claim 9, wherein the processor executes the program instructions to capture voice samples of each real-life professor from pre-recorded speech segments for generating the voice corresponding to the response.

15. The system of claim 9, wherein the processor executes the program instructions to capture a feedback of the user of said user device upon transmitting the response with voice and the one or more holographic images.

16. The system of claim 15, wherein the processor executes the program instructions to modify the one or more holographic images by changing movement of one of eyebrows, lips and body parts of the virtual realistic avatars in response to the feedback captured.

17. The system of claim 9, wherein the query received from said user device corresponds to a curriculum content.

18. The system of claim 17, wherein the curriculum content comprises one of text, multimedia, assessments, interactive learning modules, discussion forums, virtual labs, case studies, webinars, and online workshops.

19. The system of claim 9, wherein the processor executes the program instructions to integrate with an online learning management system (LMS) to facilitate the delivery of the curriculum content including educational courses, training programs, learning and development initiatives.

20. A non-transitory, computer-readable medium storing instructions that, when executed by a computer system for providing internet-based teaching utilizing a holographic projection, configure said computer system for:
receiving a query from a user device, the query corresponding to a curriculum content comprising one of text, multimedia, assessments, interactive learning modules, discussion forums, virtual labs, case studies, webinars, and online workshops;
processing the query for generating a response from the curriculum content;
generating, by said processor, one or more holographic images of a real-life professor;
generating, by said processor, a voice corresponding to the real-life professor;
integrating the response with the voice and the one or more holographic images; and
transmitting the response to said user device such that the one or more holographic images emulate a facial expression of the real-life professor while producing a human-like speech with the voice on said user device.
